(19) United States
(12) Patent Application Publication
(10) Pub. No.: US 2017/0297056 A1
(43) Pub. Date: Oct. 19, 2017

(54) METHOD FOR APPLYING NANOPARTICLES

(71) Applicant: Valinge Photocatalytic AB, Viken (SE)

(72) Inventors: Göran ZIEGLER, Viken (SE); Theis REENBERG, Kobenhavn N (DK); Henrik JENSEN, Olstykke (DK)

(73) Assignee: Valinge Photocatalytic AB, Viken (SE)

(21) Appl. No.: 15/394,874

(22) Filed: Dec. 30, 2016

Related U.S. Application Data
(63) Continuation of application No. 13/015,942, filed on Jan. 28, 2011, now abandoned.
(60) Provisional application No. 61/299,458, filed on Jan. 29, 2010.

(51) Int. Cl. B05D 3/02; B27N 3/02; B32B 5/16; B32B 37/00; B32B 27/10

(52) U.S. Cl. CPC B05D 3/02; B32B 37/00; B32B 27/10; B32B 5/16; B27N 3/02; Y10T 428/31765; Y10T 428/25

(57) ABSTRACT

A method of producing a sheet including the photocatalytic nanoparticles by applying the particles in a freshly impregnated and wet surface. The method including the steps of impregnating the sheet with a polymer resin; spraying the sheet, freshly impregnated with the polymer resin in an uncured and wet state, with an impregnation fluid composition comprising dispersed photocatalytic nanoparticles; drying and/or at least partly curing the impregnated sheet comprising the polymer resin and the impregnation fluid.

### CROSS REFERENCE TO RELATED APPLICATIONS

The present application is a continuation of U.S. application Ser. No. 13/015,942, filed on Jan. 28, 2011, which claims the benefit of U.S. Provisional Application No. 61/299,458, filed on Jan. 29, 2010. The entire contents of U.S. application Ser. No. 13/015,942 and U.S. Provisional Application No. 61/299,458 are hereby incorporated herein by reference.

### TECHNICAL FIELD

The disclosure generally relates to methods of applying nanoparticles on a surface to create a layer with embedded photo catalyst nanoparticles. Furthermore, the invention relates to a method to achieve a homogenous distribution of nanoparticles in the upper layer of boards and panels.

### BACKGROUND

It is well known to produce laminated building panels with a surface comprising laminated paper sheets. Also known is a new type of panel called Wood Fibre Floor (WFF) that is disclosed in WO 2009/065769, which shows both products and methods to produce such a product also using nanoparticles. Furthermore it is shown in WO 2009/062516 to apply nanoparticles on a laminate surface or on an overlay paper

The documents below describe several ways to treat papers or impregnated papers prior to the final oven and before the paper can be used in laminate panels.

US 2009/0208646 A1 describes a wet-in-wet application of a coating to an impregnated overlay by means of a coating inlet. The control of the thickness of the layer is obtained by wipers that wipe of the excess coating. The document shows a method of producing an overlay, in particular for laminates, involving impregnation of a paper with the following method steps:
1) Unrolling of an overlay base paper from a roll for the purpose of obtaining a paper web (10);
2) Moistening of the paper web (10) on one side with an impregnating medium (14);
3) Impregnating the paper web (10) with an impregnating medium (18)
4) Wet-in wet application of a coarse corundum and resin dispersion (27) on one side onto the paper web (10)
5) Opposite wet-in-wet application of a coating substance (29), in the form of resin and fine corundum, onto the paper web (10);
6) A dosage of the applied coating substance (29) by a wiper (32), to the desired application weight;
7) Drying the paper web (10) using a drying duct.

U.S. Pat. No. 3,798,111 describes the incorporation of particles in the paper machine where the particles can be found throughout the paper, entangled by the fibres.

WO 2007144718 discloses a hard nanoparticle suspension applied to the resin pre-treated carrier sheet. The method states that the suspension comprises resin. The method comprises adding the suspension by means of a wire doctor roll and/or a raster roll or other methods comprising rolls and/or knifes. Also air-knives.

### SUMMARY OF THE INVENTION

Embodiments of the invention relates to a method of applying nanoparticles on a surface to create a sheet or a surface layer with photocatalytic nanoparticles. The aim is to improve the effect of the photocatalytic nanoparticles when the particles are embedded in the sheet or the surface layer, i.e. keeping the activity level at a high level and maintaining the desired properties of the sheet or the layer with the embedded particles.

It is shown in WO 2009/062516 A2 to use photocatalytic nanoparticles in a surface layer for improvement of e.g. the cleanability. Furthermore a method to apply the nanoparticles is disclosed. The method according to embodiments of the invention provides an improved transparency, increased lifetime and improved distribution of the nanoparticles.

A first aspect of the invention is a method of manufacturing a sheet comprising photocatalytic nanoparticles, the method comprising the steps of:
impregnating a sheet with a polymer resin, preferably comprising wear resistant particles;
spraying the sheet, freshly impregnated with the polymer resin in an uncured and wet state, with an impregnation fluid composition comprising dispersed photocatalytic nanoparticles;
drying and/or at least partly curing said impregnated sheet comprising the polymer resin and the impregnation fluid.

The sheet may comprise cellulose fibres.

Preferably, the impregnation fluid composition comprises a solvent comprising water.

The method may comprise a step between impregnating and spraying step in which step the polymer resin is partly dried.

By applying the photocatalytic nanoparticles in a wet surface particularly the distribution of the particles is improved.

The impregnation fluid composition may comprise photocatalytic nanoparticles and a solvent, said solvent being selected from water, ethylene glycol, butyl ether, aliphatic linear, branched or cyclic or mixed aromatic-aliphatic alcohols, such as methanol, ethanol, propanol, isopropanol, butanol, isobutanol, benzyl alcohol or methoxypropanol or combinations thereof.

A second aspect of the invention is a method to produce a laminate board or panel by arranging the sheet produced according to the first aspect on a core, preferably an HDF panel and applying heat and pressure.

A third aspect of the invention is a method of manufacturing a sheet comprising photocatalytic nanoparticles, the method comprising the steps of:
mixing the photocatalytic nanoparticles in a polymer resin, to obtain an impregnation mix;
applying the impregnation mix to a sheet, preferably by spraying.

A fourth aspect of the invention is a method to produce a paper sheet comprising photocatalytic nanoparticles in the paper plant, preferably prior to rolling of the paper.

A fifth aspect of the invention is a method to produce a WFF panel comprising photocatalytic nanoparticles, the method comprises the step of:
1) Scattering of a dry mix comprising wood fibres, a thermosetting resin, preferably melamine resin, and wear resistant particles on a core;
2) Applying an organic solvent on the mix on the core;
3) Spraying an impregnation fluid composition comprising dispersed photocatalytic nanoparticles, preferably dispersed in water;
4) Applying heat and pressure.

Step 2 and 3 of the method may be applied in any of the methods disclosed in WO 2009/065769 and WO 2009/124704 for production of WFF panels.

The method is preferably performed in the numbered order 1-4.

The organic solvent preferably comprises ketone, such as acetone and methyl ethyl ketone, and/or alcohol, such as ethanol, propanol and methanol, and/or acetate, such as butyl acetate, ethyl acetate. The organic solvent is in a preferred embodiment ethanol.

In another embodiment the method comprised the step of applying, preferably before step 2, a fluid with a wetting agent on the mix, preferably in the form of water containing 1% weight content of BYK-348 from BYK Chemie. The fluid with the wetting agent and the organic solvent may also be applied together.

It is well known that a nanomaterial is not just a nanomaterial, and the characteristics of the embedded nanoparticles are important for their performance and e.g. the properties of said board or panel. In a particularly preferred embodiment in any of the aspects the embedded nanoparticles have a primary particle size or crystal size of <50 nm, such as <30 nm, preferably a primary particle or crystal size of <20 nm. Hereby, the efficacy of the nanoparticles is improved and/or less nanoparticles are needed to obtain a specific effect.

Primary particles are rarely present as individual primary particles, but in a more or less aggregated form. An efficient control of the agglomerate and/or cluster size is greatly preferred. Hence, in preferred embodiments the embedded nanoparticles have a cluster or aggregate size of <100 nm, such as <80 nm, preferably a cluster or aggregate size of <60 nm, such as <40 nm, and even more preferably a cluster or aggregate size of <30 nm, such as <20 nm. Thereby, said nanoparticles may be easier to disperse homogeneously in said overlaying layer, and said layer become more optically transparent.

In any embodiment of the present invention, the concentration of said nanoparticles in said impregnation fluid may be >1 wt %, such as >5 wt %, preferably a concentration of said nanoparticles >10 wt %, such as >15 wt %, and even more preferably a concentration of said nanoparticles >20 wt %, such as >25 wt %.

Further, in any embodiments the nanoparticles in said impregnation fluid composition may have a cluster or aggregate size of <100 nm, such as <80 nm, preferably a cluster or aggregate size of <60 nm, such as <40 nm, and even more preferably a cluster or aggregate size of <30 nm, such as <20 nm.

In all of the aspects of the invention the amount of impregnation fluid composition per square meter of overlaying sheet(s) may be in the range 1-200 ml/m2, such as in the range 5-100 ml/m2, and preferably in the range 10-50 ml/m2, such as 20-40 ml/m2, of said impregnation fluid composition per square meter of overlaying sheet(s) to be impregnated.

The polymer resin used for said polymer resin composition comprising nanoparticles, may be selected from the group comprising melamine formaldehyde resin, phenol formaldehyde resin, urea formaldehyde resin, melamine urea formaldehyde resin, acrylamide resins, urethane resins, epoxy resins, silicon resins, acrylic resins, vinylic resins or mixtures thereof.

In embodiments of the invention the photocatalytic nanoparticles in said nanoparticle polymer resin composition may be introduced as a dry powder, as a paste or as a suspension and then dispersed in the polymer resin.

In embodiments of the invention a solvent of said suspension of photocatalytic nanoparticles to be dispersed in the polymer resin composition is selected from water, ethylene glycol, butyl ether, aliphatic linear, branched or cyclic or mixed aromatic-aliphatic alcohols, such as methanol, ethanol, propanol, isopropanol, butanol, isobutanol, benzyl alcohol or methoxypropanol or combinations thereof.

Embodiments of the invention may in a sixth aspect be obtained by a method of manufacturing a board or a panel, the method comprising
providing the upper surface of a base or an assembled laminate board or panel with a coating applying a coating fluid composition comprising photocatalytic nanoparticles; and
drying and/or curing said base or laminate board or panel, subsequent to said coating step.

The coating fluid may in any of the above aspects be applied to said material surface by spraying, dipping, rolling, brushing or by other conventional application methods. The amount of coating fluid composition per square meter of said material surface may be in the range 1-200 ml/m2, such as in the range 5-100 ml/m2, and preferably in the range 10-50 ml/m2, such as 15-25 ml, of said coating fluid composition per square meter of said material surface.

Several combinations of the ingredients can be made into fully functional products. Three examples are given below as to show three functional embodiments of the innovation.

### BRIEF DESCRIPTION OF THE DRAWINGS

The disclosure will in the following be described in connection to preferred embodiments and in greater detail with reference to the appended exemplary drawing, wherein:

FIG. 1 Illustrates a production line for producing an overlay paper.

FIG. 2 Illustrates a production line for producing an overlay paper comprising spraying unit.

### DETAILED DESCRIPTION OF EMBODIMENTS

The present invention is concerned with manufacturing of an overlay or boards or panels, such as laminate boards or panels, comprising different types of photocatalytic nanoparticles, which makes the manufactured products photocatalytic active. Each layer and process step can be preferred from the others e.g. depending upon the price of the laminate boards and panels (low cost/high cost product) and the facilities available by the laminate manufacturers.

Laminate boards and panels are typically made of a base of fibre board (mainly high density fibre board HDF) and 3 or more sheets: a décor sheet, an overlay sheet of cellulose on top and one or more backing sheets sitting on the opposite side of the fibre board base to balance the board and prevent it from curving. Other sheets are often placed between the fibre board and the décor sheet. The décor sheet could be monochromatic or patterned to look like e.g. wood, cork, stone, tiles or a more abstract pattern. The overlay sheet typically contains wear resistant particles, normally a certain amount of alumina oxide (Al2O3), to give the laminate better abrasive resistance. Furthermore, the overlay sheet is impregnated with a polymer resin, typically melamine formaldehyde resin. The other sheets, most often paper sheets, are also impregnated with resin. The décor sheet is typically impregnated with melamine formaldehyde resin whereas phenol formaldehyde resin often is used in the core of the laminate. The laminate board or panel is assembled applying heat and pressure, making the resin polymerise in a thermosetting reaction. After lamination the polymerised overlay sheet and décor paper constitute the top layer of the laminate board or panel and thus needs to be optically transparent right from the upper surface of the laminate through to the decorative print of the décor paper.

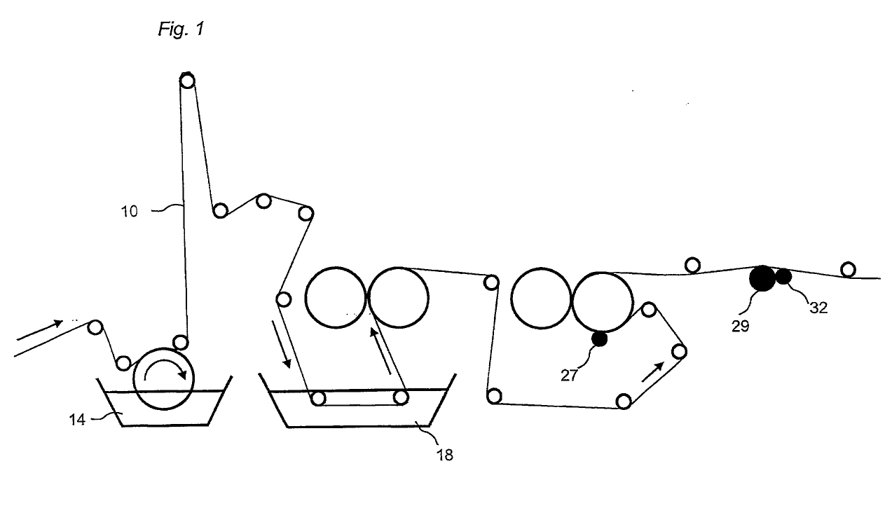

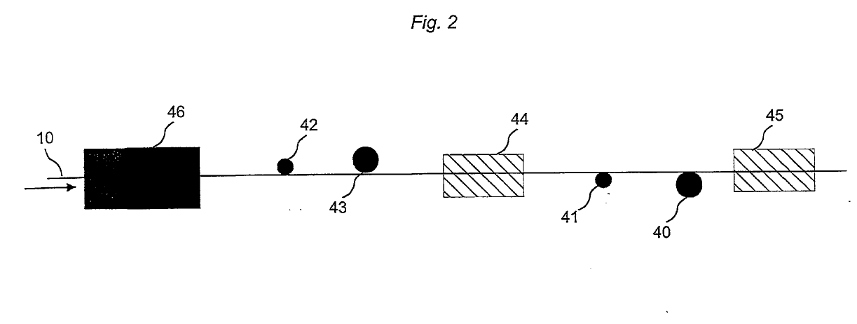

In one embodiment of the invention (FIG. 2) the photocatalytic nanoparticles are applied as a wet-in-wet spray coating (43, 40) to the upper and/or lower surface of the paper (10), after a first (42) and/or a second (41) impregnation of the paper (10) with a resin and wear resistant particles, preferably aluminium oxide. The paper may be dried (44,45) after each impregnation. Preferably the photocatalytic nanoparticles are applied after the impregnation step but before the drying step. In one embodiment the paper (10) is in a first step (46) moistened with a resin and/or impregnated in a resin through. This method of spraying the photocatalytic nanoparticles may be incorporated in any production line for producing overlay or décor paper, also in the line shown in FIG. 1 and described above under US2009/0208646. The spraying of the photocatalytic nanoparticles may in the FIG. 1 line be performed at any stage after the moistening (14) of the paper web (10).

A suitable type of spray nozzle for the spray coating of photocatalytic nanoparticles is an electronically controlled Autojet Pulsajet B10000jjau.

Preferred spray velocity of overlay or décor paper may be >1 m/s, such as >2 m/s, preferably a velocity of >5 m/s, such as >8 m/s, and even more preferably a velocity of >10 m/s.

In another embodiment the photocatalytic nanoparticles are applied as a wet-on-dry spray coating to the upper and/or lower surface of the overlay and/or décor paper, after a first or a second impregnation of the paper with resin and wear resistant particles, preferably aluminium oxide. The paper is normally dried after each impregnation.

In a preferred embodiment of the invention the photocatalytic nanoparticles may be mixed with a wetting agent and/or an alcohol prior to the spray coating step to improve the wettability of the impregnation fluid on the overlay and/or décor sheet.

In another embodiment of the invention the photocatalytic nanoparticles may be applied as a combination between wet-in-wet and wet-in-dry spray coating.

In another embodiment of the invention photocatalytic nanoparticles are applied as a polymer mixture in the resin impregnation step.

In another embodiment of the invention photocatalytic nanoparticles are incorporated into an overlay sheet, e.g., in the décor paper itself prior to polymer resin impregnation. Thus using said photocatalytic overlay sheet or décor paper a photocatalytic layer can be readily introduced applying the existing methods used for manufacturing laminate boards or panels i.e. polymer resin impregnation of the photocatalytic overlay sheet or décor paper followed by laminate board fabrication in a heat pressing laminating step.

Said photocatalytic nanoparticle impregnation and drying/curing steps may be incorporated into an existing production line immediately prior to the polymer resin impregnation of said overlay sheet or décor paper or said photocatalytic impregnated and cured overlay sheet or décor paper can be stored until needed.

A suitable type of nanoparticle for use in the coating fluid composition is Titania. The nanoparticles of Titania may according to some aspects of the present invention further comprise other elements. In some embodiments such elements may be introduced into said nanoparticles with the aim to improve the photocatalytic activity of said nanoparticles by altering the absorption range of said Mania photocatalytic nanoparticles.

The solvent of said coating fluid composition may comprise water, methanol, ethanol or isopropanol or combinations thereof, or may just be water.

The particle concentration of said photocatalytic nanoparticles in the manufactured board or panel may be increased by repeating said coating step several times.

A preferred embodiment of the produced impregnated paper comprises discrete photocatalytic nanoparticles on and in said overlay sheet or décor paper. Said nanoparticles or clusters of nanoparticles may in many applications according to the present invention be of substantially the same size as the effective particle size in said impregnation fluid composition.

The produced impregnated paper, comprising the photocatalytic nanoparticles, may be used in all known process, to produce laminated building panel, preferably floorboards, wall panels and kitchen tabletops

The photocatalytic composition to be dispersed in the polymer resin may preferably comprise photocatalytically active nanoparticles of Titania (TiO2). In a preferred embodiment said nanoparticles comprise the anatase and/or the rutile and/or the brookite crystal form of Titania or a combination thereof. Further, said photocatalytically active nanoparticles are according to the present invention predominantly present in their final crystal form in said composition i.e. no heat treatment is required for transformation of said nanoparticles into their active form. The average primary particle size or crystallite size of the nanoparticles, e.g. Titania expressed as an equivalent spherical diameter may preferably be below 30 nm, such as below 20 nm, and preferably below 15 nm, such as below 10 nm. The average primary particle size or crystallite size may be measured by X-ray Diffraction (XRD) using Scherer's formula. It is further preferred that the particle size distribution of said nanoparticles is relatively narrow.

The photocatalytic composition to be dispersed in the polymer resin, whether it is introduced as a powder, a paste or a suspension, may be added to the polymer resin at any given time. In one embodiment of the invention the photocatalytic composition is dispersed into the polymer resin immediately prior to the impregnation of overlay sheets or décor papers with polymer resin. Said dispersion process may be aided by a specially designed machine or apparatus.

### EXAMPLES

Having described the basics aspects of the invention, the following examples are given to illustrate specific embodiments thereof.

### Example 1

### Wet in Wet

This example illustrates the production of a polymeric surface containing embedded nanoparticles. The particles were applied as dispersion via a spray system onto the freshly impregnated polymeric surface while still wet.

The following dispersion was used as a feedstock. 30% TiO2 dispersion in water containing particle agglomerates of no bigger size than 80 nm as determined using the Particle Matriz Nanotrack NPA 252. The stock solution was then sprayed onto freshly impregnated melamine paper right after the paper had left the impregnation roller. The dispersion was applied onto the paper using an autojet spray system, pumping the fluid to the nozzles via a low pressure tank whit a pressure of 1.8 bar. The nozzles were pulsejet nozzles with air atomizing tips (air pressure 1.5 bar) placed 35 cm above the freshly impregnated paper right in front of the entrance to the first drying oven.

The autojet system was set to deliver 30 ml fluid/m2 of paper; the paper was then dried in two consecutive heating ovens. This yielded a melamine paper with embedded TiO2 agglomerates of a very small size, penetrating approximately the first couple of hundred micrometers of the melamine paper.

### Example 2

### Wet on Dry

This example illustrates the production of a polymeric surface containing embedded nanoparticles. The particles were applied as dispersion via a spray system onto the polymeric surface after this was dried in the heating oven.

The same liquid and spray system as used in Example 1 was used in this experiment.

### Example 3

### Wet on Raw Paper

This example illustrates the production of a polymeric surface containing embedded nanoparticles.

The particles were applied as dispersion via a spray system onto the raw paper before the paper was impregnated with melamine.

Test Results

The table below shows the result of different methods to apply the photocatalytic particles:
Test I: Applying a photocatalytic top layer by impregnation of overlay paper wet-in-wet by spraying.
Test II: Applying a photocatalytic top layer by impregnation of overlay paper wet-on-dry by spraying.
Test III: Applying a photocatalytic top layer by impregnation of overlay paper wet-on-dry by spraying on raw overlay paper before melamine impregnation.

The appearance, the stability and the distribution are evaluated.

| Treatment | Appearance (a) | Stability (b) | Distribution (c) |
|---|---|---|---|
| Blank-Reference | 1 | 1 | — |
| Test I: Wet-in-wet | 1 | 1 | 1 |
| Test II: Wet-on-dry | 2 | 1 | 3 |
| Test III: Wet-in-dry | 4 | 4 | 2 |

a) The appearance on a scale from 1-5, as judged by transparency and haziness, where 1 is no visible difference from non-embedded laminate and 5 is very hazy.

b) The process stability was evaluated on a scale from 1-5, as judged by material lifetime and flexibility, where 1 is no difference from non-embedded laminate and 5 is very sensitive to process changes.

c) The distribution of embedded particles was evaluated on a scale from 1-5, where 1 is complete homogenous distribution of photocatalytic nanoparticles.

1. Method of manufacturing a sheet comprising photocatalytic nanoparticles, the method comprising the steps of:
impregnating the sheet with a polymer resin;
spraying the sheet, freshly impregnated with the polymer resin in an uncured and wet state, with an impregnation fluid composition comprising dispersed photocatalytic nanoparticles;
drying and/or at least partly curing said impregnated sheet comprising the polymer resin and the impregnation fluid.
